(19) United States
(12) Patent Application Publication
(10) Pub. No.: US 2015/0294266 A1
(43) Pub. Date: Oct. 15, 2015

(54) DELIVERY OF PHYSICAL OBJECTS TO NON-FIXED END POINTS

(71) Applicant: Chris Siragusa, New York, NY (US)

(72) Inventor: Chris Siragusa, New York, NY (US)

(73) Assignee: MAXDELIVERY, LLC, New York, NY (US)

(21) Appl. No.: 14/341,407

(22) Filed: Jul. 25, 2014

Related U.S. Application Data
(60) Provisional application No. 61/979,146, filed on Apr. 14, 2014.

(51) Int. Cl. G06Q 10/08; H04W 4/02

(52) U.S. Cl. CPC G06Q 10/0833; H04W 4/025; H04W 4/023

(57) ABSTRACT

A delivery method provides for the delivery of an item to a mobile (non-stationary) customer. Order information is obtained from a mobile device of a customer, which includes information about the item to be delivered and a current location of the customer. Delivery information is then provided to a mobile device of a delivery person. The delivery information includes the current location of the customer. While the delivery person is en route to the customer, customer location updates are repeatedly obtained from the mobile device of the customer and used to provide updated customer location information to the mobile device of the delivery person.

### CROSS-REFERENCE TO RELATED APPLICATIONS

This application claims the benefit of U.S. Provisional Application No. 61/979,146, filed Apr. 14, 2014, the contents of which are incorporated herein by reference.

### BACKGROUND

1. Field of the Invention

Various embodiments of the invention relate to methods and systems, as well as software, for managing delivery of physical objects to mobile, non-fixed, end-points.

2. Description of the Related Art

Current dispatching and delivery systems rely on a process of placing an order and specifying a street address or other fixed point. Under this approach, delivery of goods requires the customer (or recipient) to remain in that fixed location during the time that the delivery is expected. Recipients are thus limited in their ability to receive deliveries while on the move or being at a location that does not have a proper street address.

WO2001011523, published on Feb. 15, 2001, describes dispatching systems for arranging local products to be delivered to fixed end point addresses.

U.S. Pat. No. 7,411,492, issued Aug. 12, 2008, describes using GPS information relayed over mobile communications for the tracking of pets.

European Patent No. EP2225870 A1, issued Sep. 8, 2010, describes using speech recognition technologies to locally dispatch taxi fleets to fixed end points.

The above references are incorporated by reference herein in their entirety. Despite these, and other technologies, there still remains a need to support deliveries to mobile, non-fixed end-points.

### SUMMARY OF VARIOUS EMBODIMENTS OF THE INVENTION

In one aspect, embodiments of the present invention are directed to a computer system that allows for the dispatching and delivery of physical objects or products to mobile, non-fixed end-points. Such systems could be used, for example, to schedule a local delivery of products to a customer or recipient using a mobile device while the customer is on the move, e.g., walking in a park, and have the delivery sent to the customer wherever the customer happens to be at the time of delivery. Therefore, the systems and methods of various embodiments of the invention allow consumers (or customers) to order goods or products for delivery without being tied to a physical location while waiting for the ordered products to arrive. In other aspects, embodiments of the invention are directed to the software-implemented on such a system and corresponding computer-implemented methods that perform the various functions that effect the dispatching and delivery of physical products, such as updating the location of the customer and the location of the delivery person, routing of the delivery person to the customer, as will be further described below.

Centralized server-based systems for coordination of communications between the delivery person, the central server(s), and the customer are described herein. However, it is to be appreciated that certain communications can be made directly between the consumer and the delivery person.

### BRIEF DESCRIPTION OF THE DRAWINGS

The various aspects and embodiments disclosed herein will be better understood when read in conjunction with the appended drawings, wherein like reference numerals refer to like components. For the purposes of illustrating aspects of the present application, there are shown in the drawings certain preferred embodiments. It should be understood, however, that the application is not limited to the precise arrangement, structures, features, embodiments, aspects, and devices shown, and the arrangements, structures, features, embodiments, aspects and devices shown may be used singularly or in combination with other arrangements, structures, features, embodiments, aspects and devices. The drawings are not necessarily drawn to scale and are not in any way intended to limit the scope of this invention, but are merely presented to clarify illustrated embodiments of the invention. In these drawings:

FIG. 1 shows a block diagram of a system for placing/receiving an order for delivery according to one embodiment of the present invention.

FIG. 2 shows a sample screenshot for order placement on a customer device, with an option to deliver the ordered product directly to the customer, according to an embodiment of the invention.

FIG. 3 shows a sample screenshot of a display of a delivery person device upon receiving an assigned order from the central server according to an embodiment of the invention.

FIG. 4 illustrates a map interface for a delivery person according to an embodiment of the invention.

FIG. 5 depicts communications between the customer device and central servers, and between the delivery person device and the central server, for updating the locations of both the delivery person and the customer during delivery, according to one embodiment of the invention.

FIG. 6 depicts a flowchart for a process carried out by the customer device according to an embodiment of the invention.

FIG. 7 depicts a flowchart of a process performed by the delivery person device according to an embodiment of the invention.

### DETAILED DESCRIPTION OF THE PREFERRED EMBODIMENTS

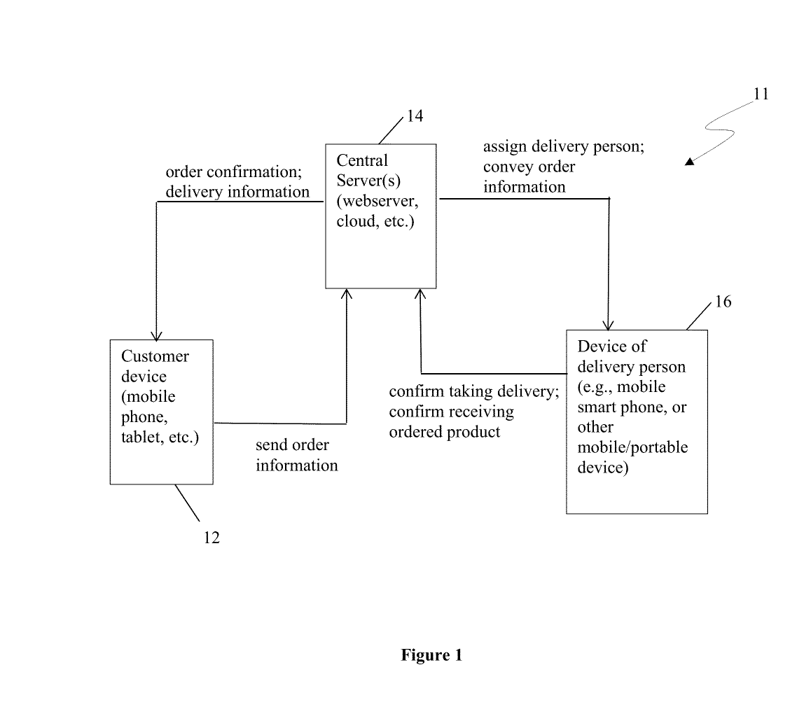

FIG. 1 shows a block diagram of a system 10 for placing/receiving an order for delivery according to one embodiment of the present invention. The system 10 includes a customer mobile device 12, a central server 14 and a delivery person mobile device 16. The mobile devices 12, 16 may be any suitable mobile device as known in the art, such as a mobile telephone, a tablet computer or the like. Each mobile device includes position-sensing equipment that is configured to determine a current location of the respective device 12, 16, as known in the art. Such position-sensing equipment can include, for example, a satellite navigation receiver, such as a GPS receiver, a GLONASS receiver, a Galileo receiver, a Compass receiver, or the like, as known in the art, as well as related processing hardware and software that uses information obtained from the receiver to generate a geo-location position fix of the device 12, 16.

The mobile devices 12, 16, and the central server 14, each include at least one processor connected to memory, the receiver and to networking hardware. The networking hardware permits the mobile devices 12, 16 to communicate with the central server 14 in a conventional manner as known in the art, and, in some embodiments, with each other. The memory stores program code executable by the respective processor to perform the various respective method steps set forth in the following for each device 12, 14, 16. In this manner, the general hardware of the mobile devices 12, 16, and of the central server 14, is transformed to create specially-configured devices that are capable of practicing an embodiment of the invention.

A customer can make an online order of a product on the mobile device 12 of the customer (“customer device”), by using a browser of the customer device 12 to access a vendor's website or using a native mobile app installed on the customer device 12 capable of performing online ordering and/or transactions. The order information can be sent to central server 14 (e.g., a computer web server or cloud server), which may or may not be the server that hosts the vendor website via a data connection (e.g., mobile networks or wireless networks). Upon receiving the order, the central server 14 can send a confirmation to the customer device 12. Also, the central server 14 assigns an appropriate delivery person, e.g., based on the customer's desired location of delivery, the delivery person's current status and location, etc. The central server 14 can send the order information (including customer information) to a device 16 of the delivery person (“delivery person device”) via a data connection. The delivery person can confirm that he or she will be making the delivery, and confirm when the ordered product is received for delivery, using the device 16. Once a delivery person is assigned and confirmed, the central server 14 can send information about the delivery person (e.g., name, contact information, characteristics in appearance) and relevant delivery information (e.g., estimated delivery time) to the customer device 12.

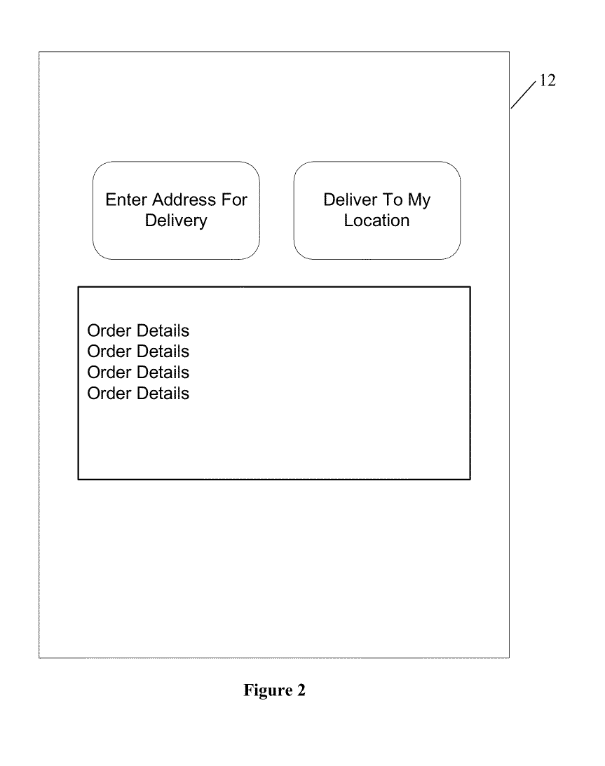

FIG. 2 shows a sample screenshot for order placement on a customer device 12, with an option to deliver the ordered product directly to the customer, according to an embodiment of the invention. This screenshot can represent a page of a website as displayed by a web browser or an interface of an embedded app on the mobile device 12. This screen and associated functionality can be implemented on any mobile device capable of providing its positioning data (e.g., GPS-enabled) and has internet connectivity. It is understood that various designs and modifications for what is shown in FIG. 2 can also be used.

The customer can be a pre-registered user of the ordering/delivery system 10, and the user information (e.g., name, contact information, billing information, etc.) can be stored on the customer device 12 and sent to the central server 14 as part of the order information. Alternatively, the customer can use the mobile device 12 to enter his information when placing the order.

If the customer selects the option of “deliver to my location,” the order information or message sent to the central server 14 indicates that the customer wishes to have the items delivered to his or her current location at the time of delivery. The message can also indicate whether the customer's mobile device 12 has the requisite ability to update the customer's position in real-time or near-real time. This communication can be performed using any standard real-time internet protocol, such as JSON or XML over HTTPS, and preferably contains sufficient information to identify the customer and ensure the validity of the message.

Upon sending the order information to the server 14, a software component on the customer's mobile device 12 can be activated to periodically obtain the current location of the customer (e.g., based on the coordinates information received from a GPS receiver of the customer device 12) and to update the delivery person with the current location of the customer, e.g., by reporting the current customer location to the central server 14, from which the delivery person device 16 can poll and obtain the last-reported customer location, or by sending the customer location directly to the delivery person device 16. To conserve battery power, the customer device 12 can send the updates infrequently at first, and more frequently when the delivery person approaches the current location of the customer. That is, the positional updates sent from the customer device 12 to the delivery person device 16 can be a function of the distance between the devices 12, 16, with the frequency of the updates increasing inversely with the distance between the mobile devices 12, 16.

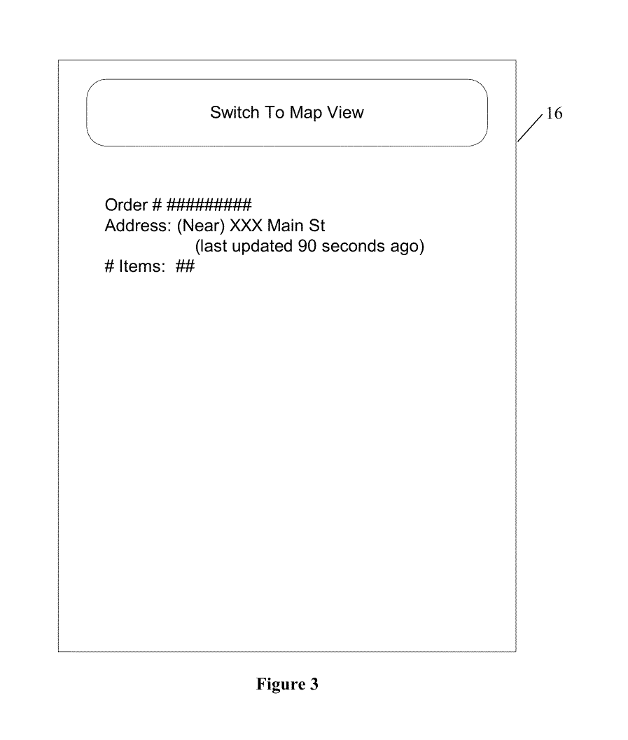

FIG. 3 shows a sample schematic screenshot of a display of a delivery person device 16 upon receiving an assigned order from the central server 14 according to an embodiment of the invention. The current location of the customer along with the information that the customer may be mobile (and therefore the actual delivery may not be at the customer's location when placing the order) can be indicated and displayed. Upon obtaining the product(s) ordered by the customer, the delivery person can indicate on the device 16 that he or she is beginning the delivery and a confirmation message can be sent to the central server 14. This screenshot can be a page of a website as displayed on a browser or an interface of a software program implemented on a mobile device 16 capable of providing positioning data (e.g., GPS-enabled) and internet connectivity. While not shown in FIG. 3, additional information regarding the order can be displayed on the delivery person device (e.g., detailed description of the ordered items, name of the customer, relevant order instructions, etc.).

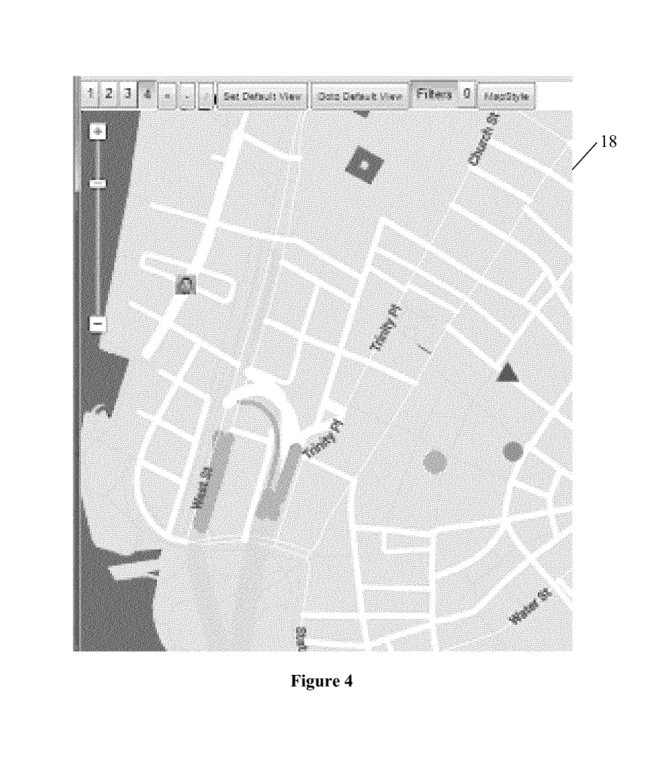

As shown in FIG. 4, the delivery person device 16 can be configured to include a map interface 18 to allow the the delivery person to view his or her own current location as well as the customer's last reported location (as retrieved by the delivery person device 16 from the server 14 or directly from the customer device 12) on the map 18. The map 18 can further show routing instructions for the current route from the delivery person to the customer. Routing can be calculated dynamically based on the current location of the delivery person and the last known or reported location of the customer using known techniques. The delivery person device 16 can be further configured to alert the delivery person if the customer has moved from the last reported or known location for more than a predetermined distance. Once the delivery person is en route, the delivery person device 16 can periodically send the current location of the delivery person device 16 to the central server 14 (which can be accessed by the customer device 12 as further described herein). Optionally, the delivery person device 16 can also directly communicate with the customer device 12 to notify the customer regarding the delivery person's current position. To conserve battery power, the delivery person device 16 can send the location updates to the central server 14 infrequently at first, and as the delivery person approaches the most recently updated location of the customer, increase the frequency of the updates.

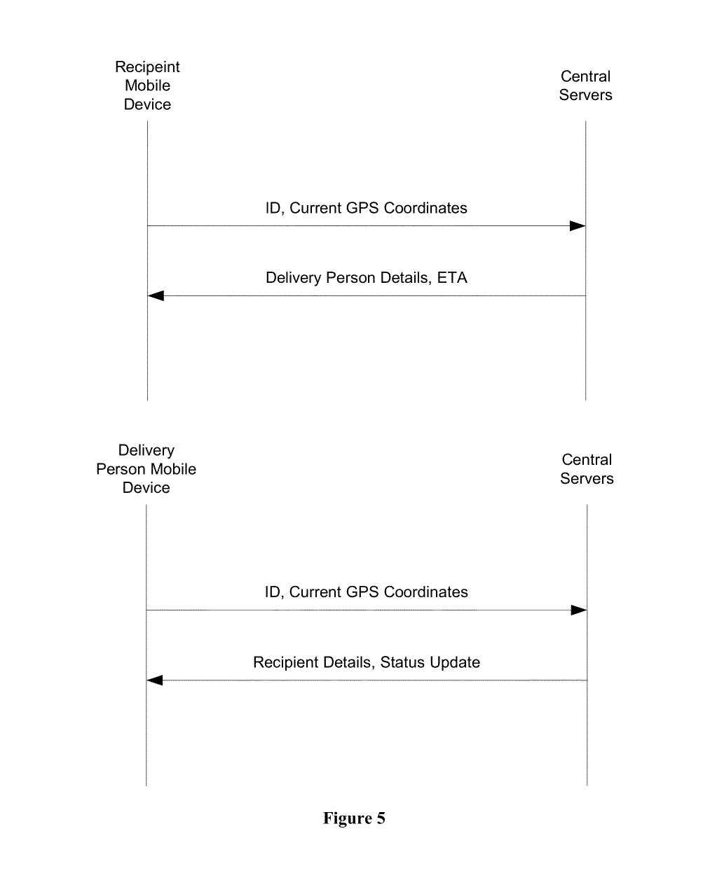

FIG. 5 depicts communications between the customer device 12 and central server 14, and between the delivery person device 16 and the central server 14, for updating the locations of both the delivery person and the customer during delivery, according to one embodiment of the invention. The mobile device 16 of the delivery person can periodically update the server 14 (or optionally, the customer device 12 directly) with the delivery person's current location. The delivery person device 16 can also receive updated information about the current location of the customer from the server 14 or directly from the customer's mobile device 12. Based upon this information, the delivery person device 16 can determine whether to re-calculate the delivery route, update the screen or interface for the delivery person, determine a suitable time for receiving the next information update about the customer's location, and provide an update to the central server 14 or directly to the customer device 12 on the estimated time of arrival (ETA). The mobile device 12 of the customer can likewise periodically update the central server 14 (or optionally, the delivery person device 16 directly) with the customer's current location, as well as receive updated information about the delivery person's current location and estimated time of arrival. Based upon this information, the customer device 12 can determine a suitable time to receive the next information update about the delivery person's location and/or estimated time of arrival, and display the information on the screen based on a screen update schedule or upon a manual request by the customer.

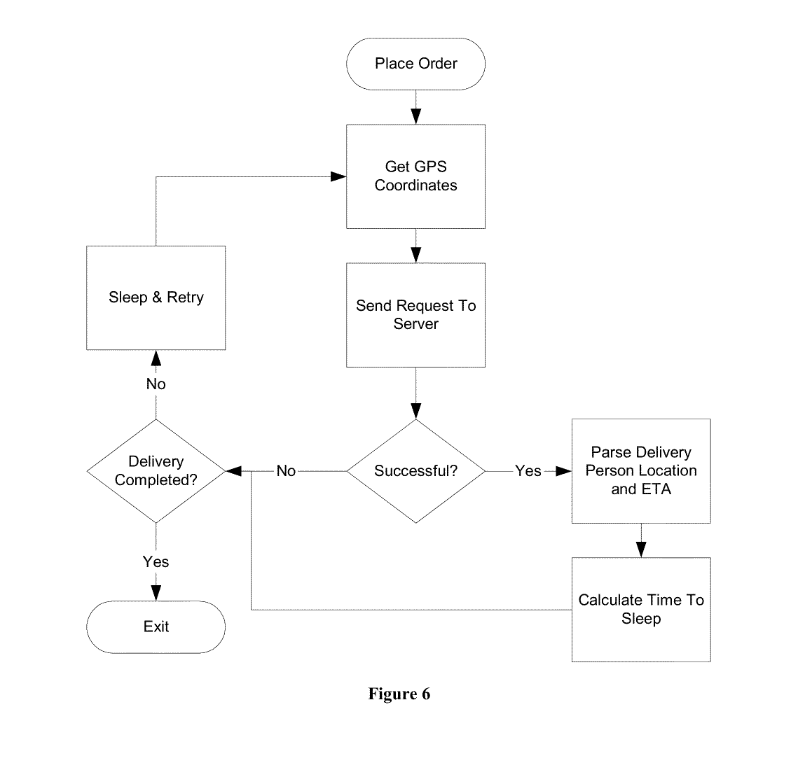

FIG. 6 depicts a flowchart for a process carried out by the customer device 12 according to an embodiment of the invention. According to a predetermined schedule, the customer device 12 can receive the latest location data from a GPS receiver installed in the customer device 12, and optionally send such location data to the central server 14. The customer device 12 can then poll the central server 14 (or receive automatic messages from the central server 14 according to a predetermined schedule) for updated location and/or ETA information regarding the delivery person. If the communication is not successful, the customer device 12 can retry the communication after a predetermined time interval and/or alert the customer regarding the communication failure. Based on the result of the poll, the customer device 12 can update its screen, if necessary, to show the current location and/or ETA of the delivery person. The customer device 12 can also calculate a suitable amount of time to sleep before sending the updated location information of the customer device 12 to the central server 14 and/or polling the server 14 again regarding the current location of the delivery person device 16. In order to limit battery usage, the customer device 12 can be configured to only poll the server 14 when the customer has moved more than a predetermined or threshold distance from the last reported location, e.g., based on the GPS positioning data provided by the customer device 12. Alternatively or additionally, the customer device 12 can allow the customer to manually enter requests for updated information about the delivery person, e.g., by activating an element (such as a software routine) on the delivery person device 16 configured to start the polling communication.

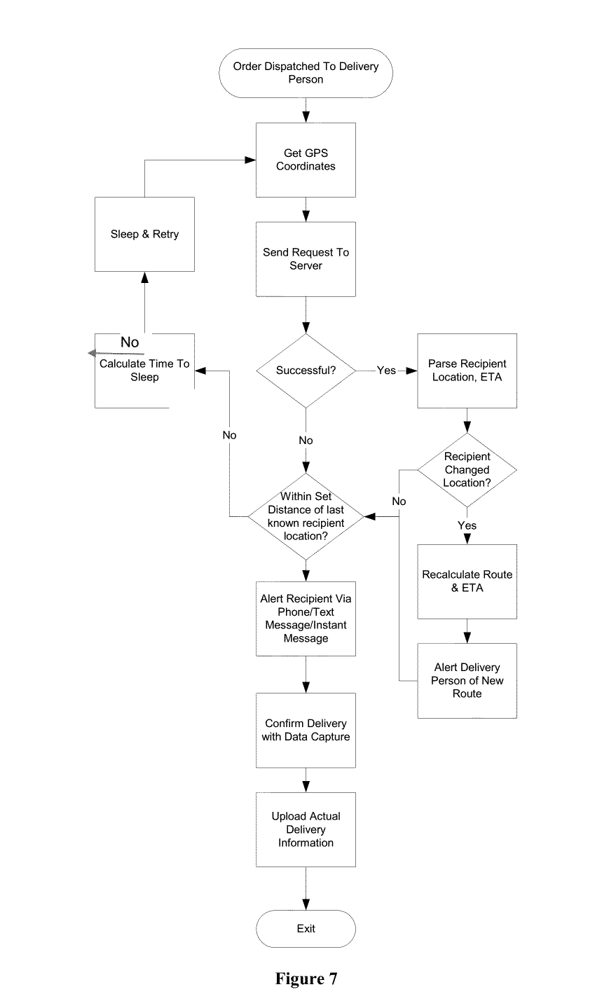

FIG. 7 depicts a flowchart of a process performed by the delivery person device 16. Upon notification that a product has been assigned to the delivery person, the delivery person device 16 can first receive the latest location data from a GPS receiver installed in the device 16, and optionally send such location data to the central server 14. The delivery person device 16 can then poll the central server 14 (or be configured to receive periodic automatic messages from the central server 14 according to a predetermined schedule) for updated location information about the customer device 12. If the communication is not successful, the delivery person device 16 can retry the communication after a predetermined time interval and/or alert the delivery person regarding the communication failure. Based on the received updated information about the customer location, the delivery person device 16 can determine if the customer has moved more than a predetermined distance from the last known location. If so, the delivery person device 16 can calculate a new appropriate route to the customer from the current location of device 16 and can optionally show the route (or routes) on a map 18 of the delivery person device 16 and alert the delivery person of the new route. The delivery person device 16 can also calculate a suitable amount of time to “sleep” before sending the updated location information to the central server 14 and/or performing the polling process again regarding the current location of the customer device 12.

Upon the delivery person device 16 detecting that the delivery person is within a predetermined distance from the customer device 12 (or upon the delivery person's request), the delivery person device 16 can prompt the delivery person to initiate a direct communication message with the customer, e.g., through text message, instant message or phone call. In this manner, the delivery person can arrange the final steps of the delivery and prepare the customer for completing the transaction.

At completion of the delivery, the delivery person device 16 can be used to confirm delivery, e.g., via scanning of the delivered items, tapping of the delivery person device with the customer device to exchange data confirming delivery, data entry and/or signature capture on the delivery person device 16, or any other suitable delivery confirmation means. Thereafter, the delivery person device 16 can notify the central server 14 that the delivery has been completed, record information such as the final GPS coordinates of the delivery location, the time of the delivery and other information captured during the delivery process (e.g., scans, taps, data entry, and/or signature captures). Upon confirmation of the order delivery, the processes illustrated in FIGS. 4-6 can be terminated with regard to the subject delivery.

Various modifications of the invention in addition to those described herein will become apparent to those skilled in the art from the foregoing description and the accompanying figures. It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention. While there had been shown and described fundamental features of the invention as applied to being exemplary embodiments thereof, it will be understood that omissions and substitutions and changes in the form and details of the disclosed invention may be made by those skilled in the art without departing from the spirit of the invention. Moreover, the scope of the present invention covers conventionally known, future developed variations and modifications to the components described herein as would be understood by those skilled in the art.

What is claimed is:

1. A delivery method comprising:
obtaining order information from a mobile device of a customer, the order information comprising information concerning an item to be delivered to the customer and a location of the customer;
providing delivery information to a mobile device of a delivery person, the delivery information comprising the location of the customer; and
while the delivery person is en route to the customer to deliver the item to the customer, repeatedly obtaining customer location updates from the mobile device of the customer and utilizing the customer location updates to provide updated customer location information to the mobile device of the delivery person.

2. The delivery method of claim 1 further comprising, while the delivery person is en route to the customer to deliver the item to the customer, repeatedly obtaining delivery person location updates from the mobile device of the delivery person.

3. The delivery method of claim 2 further comprising utilizing the delivery person location updates and the customer location updates to determine distance between the customer and the delivery person as a function of time, and wherein a frequency of the customer location updates is adjusted based on the distance between the mobile device of the customer and the mobile device of the delivery person.

4. The delivery method of claim 3 wherein the frequency of the customer location updates is inversely proportional to the distance between the mobile device of the customer and the mobile device of the delivery person.

5. The delivery method of claim 2 further comprising utilizing the delivery person location updates and the customer location updates to determine distance between the customer and the delivery person as a function of time, and wherein a frequency of the delivery person location updates is based on the distance between the mobile device of the customer and the mobile device of the delivery person.

6. The delivery method of claim 5 wherein the frequency of the delivery person location updates is inversely proportional to the distance between the mobile device of the customer and the mobile device of the delivery person.

7. The delivery method of claim 2 further comprising, while the delivery person is en route to the customer to deliver the item to the customer, utilizing the delivery person location updates to provide updated delivery person location information to the mobile device of the customer.

8. The delivery method of claim 2 further comprising assigning delivery of the item to the delivery person based upon a current position of the mobile device of the delivery person and a current position of the mobile device of the customer.

9. The delivery method of claim 2 further comprising utilizing the delivery person location updates and the customer location updates to determine distance between the customer and the delivery person as a function of time, and when the distance is less than a predetermined distance sending a corresponding message to the mobile device of the customer.

10. The method of claim 1 further comprising, in response to receiving a delivery confirmation message from the mobile device of the delivery person, ceasing requesting customer location updates from the mobile device of the customer.

11. A computer system comprising:
at least one processor;
networking hardware coupled to the processor; and
a memory readable by the processor, the memory comprising program code executable by the processor to cause the processor to perform steps comprising:
utilizing the networking hardware to obtain order information from a mobile device of a customer, the order information comprising information concerning an item to be delivered to the customer and a location of the customer;
utilizing the networking hardware to provide delivery information to a mobile device of a delivery person, the delivery information comprising the location of the customer; and
while the delivery person is en route to the customer to deliver the item to the customer, utilizing the networking hardware to repeatedly obtain customer location updates from the mobile device of the customer and utilizing the customer location updates and the networking hardware to provide updated customer location information to the mobile device of the delivery person.

12. The computer system of claim 11 wherein the program code further comprises the step of, while the delivery person is en route to the customer to deliver the item to the customer, utilizing the networking hardware to repeatedly obtain delivery person location updates from the mobile device of the delivery person.

13. The computer system of claim 12 wherein the program code further comprises the step of utilizing the delivery person location updates and the customer location updates to determine distance between the customer and the delivery person as a function of time, and wherein a frequency of the customer location updates is based on the distance between the mobile device of the customer and the mobile device of the delivery person.

14. The computer system of claim 13 wherein the frequency of the customer location updates is inversely proportional to the distance between the mobile device of the customer and the mobile device of the delivery person.

15. The computer system of claim 12 wherein the program code further comprises the step of utilizing the delivery person location updates and the customer location updates to determine distance between the customer and the delivery person as a function of time, and wherein a frequency of the delivery person location updates is based on the distance between the mobile device of the customer and the mobile device of the delivery person.

16. The computer system of claim 15 wherein the frequency of the delivery person location updates is inversely proportional to the distance between the mobile device of the customer and the mobile device of the delivery person.

17. The computer system of claim 12 wherein the program code further comprises the step of, while the delivery person is en route to the customer to deliver the item to the customer, utilizing the delivery person location updates and the networking hardware to provide updated delivery person location information to the mobile device of the customer.

18. The computer system of claim 12 wherein the program code further comprises the step of assigning delivery of the item to the delivery person based upon a current location of the mobile device of the delivery person and a current location of the mobile device of the customer.

19. The computer system of claim 12 wherein the program code further comprises the step of utilizing the delivery person location updates and the customer location updates to determine distance between the customer and the delivery person as a function of time, and when the distance is less than a predetermined distance utilizing the networking hardware to send a corresponding message to the mobile device of the customer.

20. The computer system of claim 11 wherein the program code further comprises the step of, in response to receiving a delivery confirmation message from the mobile device of the delivery person, ceasing requesting customer location updates from the mobile device of the customer.

21. A non-ephemeral computer-readable media storing program code executable by a processor to cause the processor to perform steps comprising:
utilizing networking hardware coupled to the processor to obtain order information from a mobile device of a customer, the order information comprising information concerning an item to be delivered to the customer and a location of the customer;
utilizing the networking hardware to provide delivery information to a mobile device of a delivery person, the delivery information comprising the location of the customer; and
while the delivery person is en route to the customer to deliver the item to the customer, utilizing the networking hardware to repeatedly obtain customer location updates from the mobile device of the customer and utilizing the customer location updates and the networking hardware to provide updated customer location information to the mobile device of the delivery person.

22. The computer-readable media of claim 21 wherein the program code further comprises the step of, while the delivery person is en route to the customer to deliver the item to the customer, utilizing the networking hardware to repeatedly obtain delivery person location updates from the mobile device of the delivery person.

23. The computer-readable media of claim 22 wherein the program code further comprises the steps of:
while the delivery person is en route to the customer to deliver the item to the customer, utilizing the networking hardware to repeatedly obtain delivery person location updates from the mobile device of the delivery person; and
utilizing the delivery person location updates and the customer location updates to determine distance between the customer and the delivery person as a function of time;
wherein a frequency of the customer location updates or a frequency of the delivery person location updates is based on the distance between the mobile device of the customer and the mobile device of the delivery person.

24. The computer-readable media of claim 23 wherein the frequency of the delivery person location updates or the frequency of the customer location updates is inversely proportional to the distance between the mobile device of the customer and the mobile device of the delivery person.

25. The computer-readable media of claim 22 wherein the program code further comprises the step of, while the delivery person is en route to the customer to deliver the item to the customer, utilizing the delivery person location updates and the networking hardware to provide updated delivery person location information to the mobile device of the customer.
